(19) United States
(12) Patent Application Publication
(10) Pub. No.: US 2010/0277421 A1
(43) Pub. Date: Nov. 4, 2010

(54) Device with a Transparent Display Module and Method of Incorporating the Display Module into the Device

(75) Inventors: Michael L. Charlier, Palatine, IL (US); Thomas E. Gitzinger, Libertyville, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/433,275

(22) Filed: Apr. 30, 2009

(51) Int. Cl. G06F 3/041

(52) U.S. Cl. 345/173

(57) ABSTRACT

A portable electronic device including a transparent display module, and a method of incorporating a transparent display module into a portable electronic device, are provided. The portable electronic device includes a front side surface which is intended to be primarily used facing toward a principal user and a back side surface, which is intended to be primarily used facing away from the principal user. The portable electronic device includes a transparent display module including a primary light emitting transparent display having a first side surface and a second side surface, which emits a light toward each of the first side surface and the second side surface in disproportionate amounts, where an amount of light emitted toward the first side surface is less than an amount of light emitted toward the second side surface. The transparent display module is mounted in the portable electronic device, so that the first side surface of the transparent display module which emits the lesser amount of light is oriented toward the front side surface of the portable electronic device, and the second side surface of the transparent display module which emits the greater amount of light is oriented toward the back side surface of the portable electronic device.

### FIELD OF THE INVENTION

The present invention relates generally to display modules for use in portable electronic devices, and more particularly, to dual sided transparent display modules.

### BACKGROUND OF THE INVENTION

With the trend for smaller hand held devices, such as cell phones, and the need to continue to generally reserve surface space for the positioning of interactive elements for purposes of enabling the user to interact with the device, the use of touch sensitive displays, which enable a device to visually convey information to a user, as well as enable a user to interact contextually with displayed object and otherwise provide user input to the device is increasingly being used. Touch sensitive displays merge input and output functions for some portable electronic devices, which in absence of the use of a similar and/or alternative form of input/output merging capability might otherwise require their own dedicated portions of the device surface. For example, many devices have historically incorporated a separate display and keypad on distinct portions of the external surface of the device.

However, some device designs have been able to extend the size of the display by extending it to include the surface space of the device that might otherwise have been separately dedicated to the location of a keypad. In some such instances, keypad-like input capabilities have been provided and/or maintained through the use of touch sensitive capabilities built into the extended display. One of the benefits of such a merger is the ability to dynamically change the size, shape and arrangement of keys, where each key can correspond to a subset of the surface space of the touch sensitive display associated therewith. Furthermore, each key can be accompanied by a visual indication, generally, through the integrated display, and more specifically the portions of the display that are currently active for providing each currently permissible form of user key selection and/or the immediately adjacent portions.

However one of the difficulties associated with touch screen displays includes the possibility that portions of the display become obstructed by one's fingers or hands in circumstances during which the user is simultaneously attempting to provide user input through the touch sensitive display interface, while one is attempting to view the information being presented via the display. Furthermore, interaction with the display with one's fingers can often leave smudges, which while they do not generally affect the operation of the device, can sometimes affect the appearance of the device, and may also impact the perceived image quality.

Consequently, some devices have incorporated touch sensitive surfaces that are located on the back side of the device, which are intended for use by the user to interact with and/or select items, which are being displayed on the front side of the device. However sometimes it can be less than clear which location on the front facing display corresponds to particular position being currently touched on the back of the device.

Correspondingly the present inventors have recognized that it would be beneficial to incorporate a transparent display having window-like characteristics into a portable electronic device. However, under at least some conditions windows are not always transparent, depending upon the nature of external lighting conditions. For example, under some circumstances the surface of a window may be more reflective, such as in instances where one is attempting to look through a window from the same side having relatively brighter lights, which can be akin to attempting to look through a window into a house from the outside of the house on a bright sunny day. Further, window-like transparent display modules may not provide sufficient transparency in some use cases to enable one to simultaneously see behind the device while concurrently producing an item to be visually represented to the user via the display. Correspondingly, the present inventors have recognized that it would be beneficial if the transparent display module could be arranged within a device and configured for use such that the user could more readily correlate a particular point associated with the back of the device, with which the user is currently interacting, and the corresponding point or object being displayed on the screen, which is visible via the front of the device, and correspondingly integrate a transparent display module so as to more readily enable objects located or interacting with the back surface of the device to be visible by the user from the front side of the device.

### SUMMARY OF THE INVENTION

The present invention provides a portable electronic device having a front side surface, which is intended to be primarily used facing toward a principal user and a back side surface, which is intended to be primarily used facing away from the principal user. The portable electronic device includes a transparent display module including a primary light emitting transparent display having a first side surface and a second side surface, which emits a light toward each of the first side surface and the second side surface in disproportionate amounts, where an amount of light emitted toward the first side surface is less than an amount of light emitted toward the second side surface. The transparent display module is mounted in the portable electronic device, so that the first side surface of the transparent display module which emits the lesser amount of light is oriented toward the front side surface of the portable electronic device, and the second side surface of the transparent display module which emits the greater amount of light is oriented toward the back side surface of the portable electronic device.

In at least one embodiment, elements located behind the device can be seen in conjunction with and through an image produced by the primary light emitting transparent display.

In at least a further embodiment, the display module further includes a secondary light emitting transparent display, which at least partially overlaps with the primary light emitting transparent display in a direction perpendicular to an image plane of each of the primary light emitting transparent display and the secondary light emitting display. The secondary light emitting transparent display has a first side surface and a second side surface, which emits a light toward each of the first side surface and the second side surface in disproportionate amounts. An amount of light emitted by the secondary light emitting transparent display toward the first side surface is less than an amount of light emitted toward the second side surface, where the first side surface of the secondary light emitting transparent display is oriented in the same direction of the first side surface of the primary light emitting transparent display.

The present invention further provides a method for using one or more light emitting transparent displays in a portable electronic device. The method includes placing a primary light emitting transparent display into a portable electronic device, such that a first side surface of the primary light emitting transparent display is oriented toward a front side surface of the portable electronic device, which is intended to be primarily used facing toward a principal user, and such that a second side surface of the primary light emitting transparent display is oriented toward a back side of the portable electronic device, which is intended to be primarily used facing away from the principal user. An image is then emitted via the primary light emitting transparent display, so that a lesser amount of light associated with the image is emitted toward the first side surface of the primary light emitting transparent display, and a greater amount of light associated with the image is emitted toward the second side surface of the primary light emitting transparent display.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a plan view of an exemplary portable electronic device incorporating a dual sided transparent display module, in accordance with at least one embodiment of the present invention;

FIG. 2 is a further plan view of the exemplary portable electronic device, illustrated in FIG. 1, further highlighting an example of user interaction with the device;

FIG. 3 is an exemplary isometric view of a multi layer stack up for a dual sided display module for use in a hand held electronic device;

FIG. 4 is a partial cross sectional side schematic view of an exemplary two layer organic light emitting display;

FIG. 5 is a partial cross sectional side view of a light emitting display, highlighting the actuation of a display element, and an exemplary emission of light from the actuated element, in accordance with at least one aspect of the present invention;

FIG. 6 is a partial cross sectional side view of a light emitting display, which includes a primary light emitting display and a secondary light emitting display;

FIG. 7 is a flow diagram of a method for using one or more light emitting transparent displays in a portable electronic device; and

FIG. 8 is a further flow diagram of a method of using one or more light emitting transparent displays in a portable electronic device, in accordance with the method illustrated in FIG. 7, and including incorporating a secondary light emitting transparent display in addition to a primary light emitting transparent display, in a portable electronic device.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated. Furthermore, while the various figures are intended to illustrate the various claimed aspects of the present invention, in doing so, the elements are not necessarily intended to be drawn to scale. In other word, the size, shape and dimensions of some layers, features, components and/or regions for purposes of clarity or for purposes of better describing or illustrating the concepts intended to be conveyed may be exaggerated and/or emphasized relative to other illustrated elements.

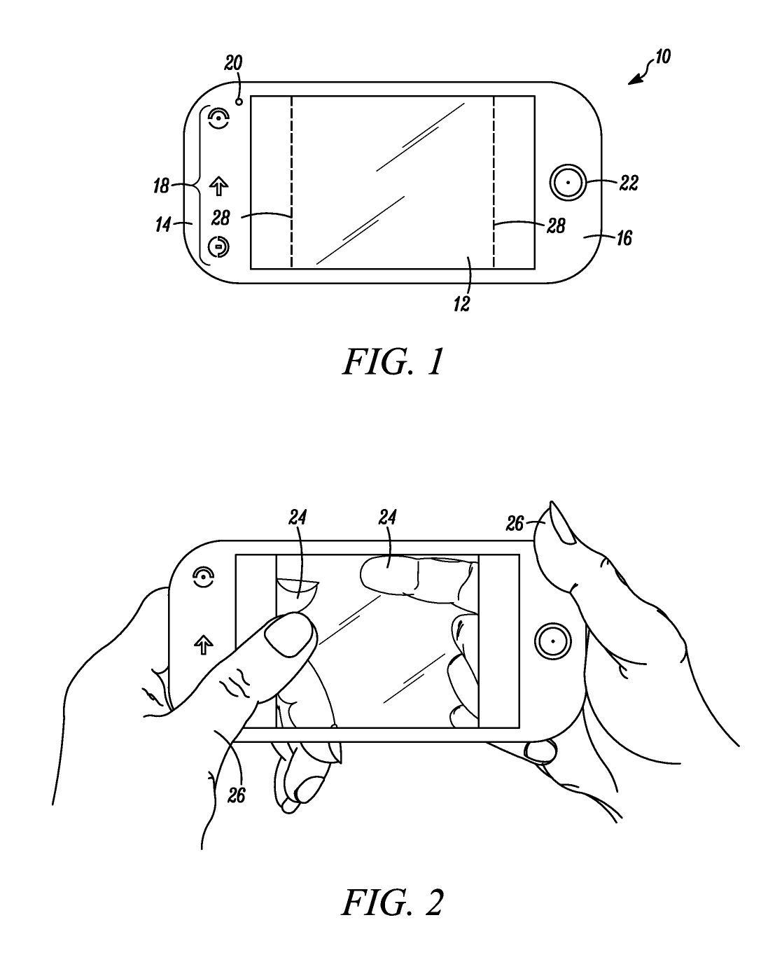

FIG. 1 illustrates a plan view of an exemplary portable electronic device 10 incorporating a dual sided transparent display module 12, in accordance with at least one embodiment of the present invention. In the illustrated embodiment, the display module 12 is generally centrally located relative to the front facing of the device 10, and generally provides a viewing characteristic and arrangement relative to the other features of the device 10, that enables one to see through the device 10 in at least portions of the area corresponding to the display, in a manner, which is at least somewhat similar to a window. While the display module 12 has a front surface and a back surface, as well as internal structure, the structure is largely comprised of transparent materials, partially transparent, or materials that can be selectively transparent, which enables one to see through the structure in order to see objects located on the other side of the device 10 and/or display in at least some operational modes, as well as view elements imaged by the display module 12 including in at least some instances from both sides of the display module 12.

In the particular embodiment illustrated, the front portion of the display module 12 extends across a significant portion of the front facing of the device 10 with the exception of areas 14, 16 to each of the left and the right of the display. For example to the left of the display, an area 14 incorporating a set of dedicated keys 18 is illustrated. This area 14 might correspond to the bottom of the device 10 when the device 10 is oriented in support of voice communications and can include a microphone 20, where the device might be positioned proximate the user's mouth for picking up voice signals via the microphone 20. Alternatively, the area 16 to the right of the display, which might correspond to the top of the device when oriented in support of voice communications, could include a speaker 22 for positioning proximate the user's ear for conveying reproduced audio signals, which could be encoded as part of a signal received by the device 10.

As part of the display module 12, surfaces can be incorporated coinciding with each of the front side surface of the device 10 and the back side surface of the device 10 from which visual elements can be imaged so as to be viewable by a user. The surfaces of the display module 12 coinciding with each of the front side surface of the device 10 and the back side surface of the device 10 can also respectively include a touch sensitive input array, that can be used to track the location and movement of a pointer, for example a user's finger 24 or thumb 26, as illustrated in FIG. 2, and/or possibly a stylus or other pointer type device positioned proximate one or both surfaces of the device. The tracking of the location and the movement of a pointer enables the device to detect prearranged patterns or positions, thereby enabling the user to potentially interact with elements being displayed by one or more displays incorporated as part of the display module 12, and/or trigger the selection or start of one or more functions that can then be executed by the device 10.

By incorporating a touch sensitive surface on both sides of the device, the user can interact with the device by touching one or both surfaces. This enables a user to select displayed elements, and associate a desired command or interactive effect which can be used to select and/or manipulate a particular desired displayed element, or more generically a function relative to the device, itself. The interaction with a displayed element or the device 10 can be achieved through interactions with the touch sensitive surfaces of the display module 12 from either the front or the back. With respect to some gestures or interactions with the device 10 or a displayed element, in at least some instances, the effect may be the same regardless as to whether the gesture or interaction is performed relative to the front surface or back surface of the device 10. In other instances, the particular effect associated with a particular gesture or interaction may be different depending upon the side from which the gesture is performed and correspondingly detected. In still further instances, a gesture or interaction with the device 10 can incorporate a selected positioning and movement that tracks multiple separate pointer positions on the same or alternative surfaces. In this way various different gestures can be defined, so as to enable multiple types of interactions to be performed, relative to the display module or a selected displayed element.

Given the transparent nature of the display module 12, and the fact that the display module in some instances may be intended to be seen through from one side to the other, and can accommodate the display of image elements that can be seen through portions of the device and may in some circumstances be viewed from both sides of the device, the placement of other non-display related device elements, such as communication and control circuitry, processing circuitry and energy storage elements may be somewhat restricted. More specifically device elements that are not transparent, partially transparent, and/or selectively transparent, generally may not want to be placed in an area where it is intended for the user to be able to see through the corresponding portions of the display module, otherwise they could potentially be seen and/or could obstruct the ability of the user to see through the display module and the associated portions of the device. Consequently, many of the circuit elements, that are not associated with the transparent portions of the display, are placed in the areas that do not allow for the more window-like observations through the device.

In at least some embodiments, the size of the viewable display portion of the display module on one side of the device and correspondingly the display module may be of a different size than the viewable display portion of the display module on the other side of the device. In such an instance, the viewing side surface (front or back) of the display module 12 that is larger will likely extend into areas that do not have potentially transparent see through window-like characteristics. Such areas are similarly possible in instances where one window is not necessarily larger than the other, but in instances where the two viewing sides of the display module 12 are laterally offset to produce a potentially similar affect for each of the respective viewing sides.

One of the effects of such an area for one of the viewing sides of the display module 12, which does not have a respective see through arrangement, is the ability to have portions of the display which is viewable against an opaque background, and in which the information that is being displayed for such an area for the particular side is not viewable from the other side. Such non-transparent regions can be sized and arranged to increase the overall size of the viewable display, relative to a particular side, while providing some transparency for seeing through the device 10, which can then be used to better confirm the position of a pointer interacting with the touch sensitive back surface of the device 10 and display module 12. Furthermore, the inclusion of the non-transparent regions within a given display area allows for an increase in the size of the areas, such as the left side area 14 and the right side area 16 described in connection with FIG. 1, that can be used to place non transparent device elements, such as the ones noted above, in areas which do not interfere with the more window-like effect of the transparent portions of the transparent display module 12.

Dashed lines 28, shown in FIG. 1, illustrate one potential boundary line for a smaller viewing portion associated with the back side surface of the device, which in turn limit the portions of the viewable area of the display associated with the front side surface of the device, through which the user can see in window-like fashion. FIG. 2 illustrates the potential impact such a smaller viewing area might have on the ability to see objects, such as pointing elements, that might be at least partially visible through the device.

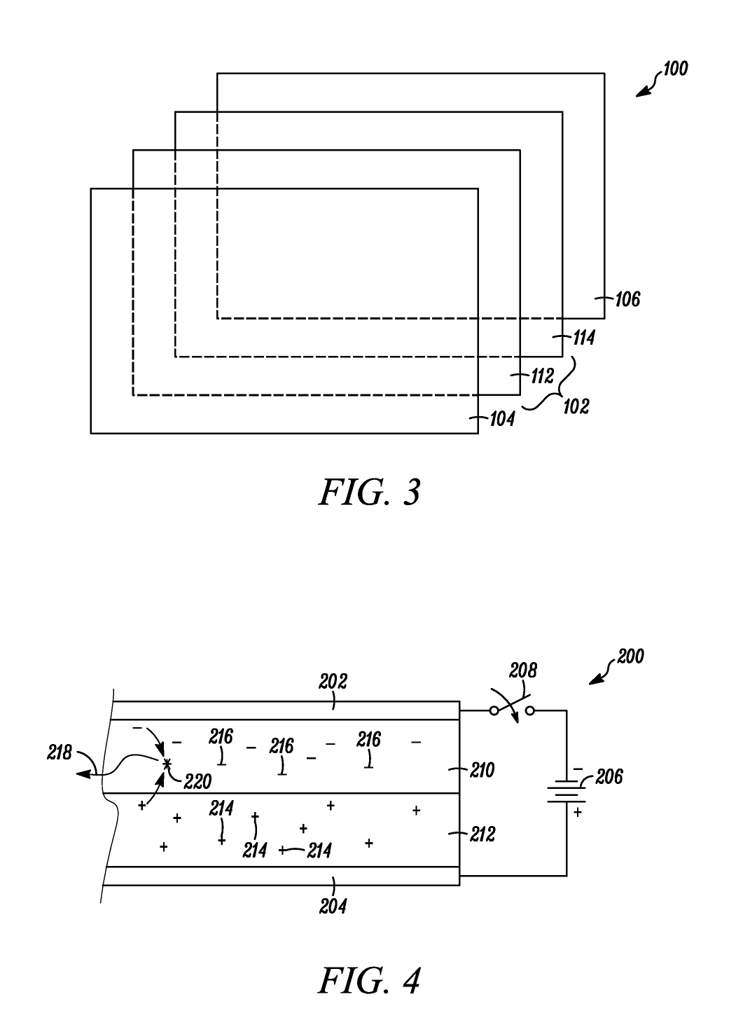

FIG. 3 illustrates an exemplary isometric view of a multi layer stack up for a dual sided display module 100 for use in a hand held electronic device. The dual sided display module 100 includes a display screen 102, which may include one or more layered displays. In the particular example illustrated, the display screen 102 includes a pair of displays, a primary side display 112 and a secondary side display 114 upon which one or more visual elements that can be perceived by the user are intended to be displayed. The primary side display 112 is generally more proximate a primary viewing side, which is intended to be facing toward a primary user during usage. The secondary side display 114, is generally less proximate the primary viewing side.

Where multiple displays are used, the general intent in some instances is to enable the possibility that elements displayed on the respective displays to be simultaneously viewable by a user in at least some operating modes or configurations. In such instances, the display elements might be viewed as being superimposed upon one another, which might give the display the appearance of some having some depth. In other instances the display might have discreet planes that are distinguishable by the user, whereby the user interaction with the displayed elements may be dependent upon the particular display upon which the corresponding element is being displayed. For example one of the displays may be associated with a foreground, and another one of the displays may be associated with a background. However, whether the elements produced on multiple displays, and/or whether objects located behind the transparent device will be visible to the user is largely dependent upon the relative intensity of the light which is received by the user and carries the visual properties that allow the user to perceive the intended image. It is possible, that just like the light of the sun can often times overpower the light of the other stars, thereby making the latter largely imperceivable during the day, the light from one or more of the light producing elements may make it difficult to perceive the light from another light producing element. Such a concern can similarly extend to the ability to perceive non-light emitting elements, which might rely upon reflected light, such as fingers interacting with the back surface of the device, in order to be perceived.

The present inventors have recognized that some transparent light emitting displays can be adapted and configured to emit light in varying amounts in different directions, and that by managing the intensity of the light that is emitted in each of a pair of directions (front and back), that perceivable transparency and/or the ability to simultaneously perceive the visual output of multiple stacked displays can be affected. Still further, the present inventors have recognized that the amount of light that is emitted by a transparent light emitting display toward the rear side of the device, in a direction that is away from the principal user interacting with the device from the front side of the device, contributes to the amount of light that is available to be reflected off of an object located behind the device, which can then be received back through the transparent display and be perceived by the user.

In at least some instances, the displays are arranged as and/or include a plurality of separately addressable display elements, which can be separately actuated to produce a varied visual effect. In some of these instances a plurality of separately addressable elements, sometimes referred to as pixels, are arranged in a substantially planer two dimensional grid-like pattern. The pixels themselves often involve individual elements that can support at least a pair of states, that produce at least two different observable visual effects, such as a light being on or off, or an element being transparent or opaque. The visual state of multiple pixel elements can be controlled, and when viewed together can produce different visual images and effects.

An example of suitable display technologies that might be used with the present application includes a light emitting display, such as a light emitting diode type display, which can include individually addressable elements (i.e. pixels), that can be used to form the visual elements to be displayed. In at least one instance an organic light emitting diode display can be used. The advantage to using a light emitting type display is that a separate light source need not be used, such as backlighting or the use of a reflective back surface, for producing a user perceivable image, at least some of which would be difficult to incorporate in the context of a transparent window-like display.

In the particular exemplary embodiment illustrated, on one side of the display screen 102 a primary side touch sensitive interface 104, corresponding to a primary side of a device, is shown. On the other side of the display screen 102 a secondary side touch sensitive interface 106, corresponding to a secondary side of the device, is shown. However, the terms primary and secondary are relative and could easily be interchanged, but together generally refer to the elements corresponding to opposite sides of the device. It is further possible that dual sided display module 100 could include still further elements, but the present description has focused on these elements as they help serve as the basis and are later referenced in connection with the discussion of some of the further features later described in the present application.

Each of the primary side touch sensitive interface 104 and the secondary side touch sensitive interface 106 can be used to detect the interaction and movement of the pointer relative to a respective surface of the device. The touch sensitive interfaces 104 and 106 can each make use of several different types of touch tracking technologies, including touch technology that is capacitive and/or resistive in nature. However depending upon the type of technology selected it may be capable of detecting different types of pointers, as well as different types of interactions with the touch sensitive interfaces 104 and 106.

In the case of capacitive-type touch sensitive interfaces, the interface can produce a detection field that can extend through a dielectric substrate, such as glass or plastic, and can be used to detect the proximity of a conductive mass that enters or disturbs the one or more fields often arranged as an array of elements in a grid-like pattern. Generally, a touch sensitive interface 104 or 106 of this type will produce a plurality of electric fields, associated with a plurality of capacitive sensors which can be sensed to determine the presence and the current location of an encroaching conductive mass that has interacted with the respective fields. Such touch sensors are sometimes referred to as proximity touch sensor arrays.

In the case of resistive-type touch sensitive interfaces, the interface includes a plurality of points often arranged as an array of elements positioned in a grid-like pattern whereby the amount of pressure being applied can be detected. In such an instance an array of elements in which the resistance will vary dependent upon the amount of force applied can be used to not only detect the presence and location of a touch, but at the same time provide an estimate to the amount of force being applied. Such touch sensors are sometimes referred to as force sensing touch sensor arrays. Because the force sensing is local relative to each detection point, a form of direct and discreet contact with the array of touch sensors may need to be possible, which often limits the opportunities for the presence of and/or the type of intervening layers.

One skilled in the art will readily recognize that there exists still further types of touch detection technologies, each having their own set of limitations and features, which can be used without departing from the teachings of the present application.

FIG. 4 illustrates a partial cross sectional side schematic view of an exemplary two layer organic light emitting display 200. More specifically, the partial cross sectional side schematic view corresponds to a separately addressable display element, which can be combined with other separately addressable display elements in forming a larger overall display. The exemplary two layer organic light emitting display 200 includes a cathode 202 and an anode 204. The two layer organic light emitting display 200 additionally includes an emissive layer 210 and a conductive layer 212

By selectively applying respective ones of a pair of terminals of a source 206 of a voltage differential to each of the cathode 202 and the anode 204 via a switch 208, the display element can be switched between at least two separate states. In the first state, the voltage differential is not applied across the anode 204 and the cathode 202, and the display element is largely off or is not producing light in the visual spectrum. In a second state, the voltage differential is applied across the anode 204 and the cathode 202, with the positive terminal of the source 206 of the voltage differential being applied to the anode 204 and the negative terminal of the source 206 of the voltage differential being applied to the cathode 202, which results in positively charged holes 214 being produced and/or injected proximate the anode 204, and negatively charged electrons 216 being produced and/or injected proximate the cathode 202.

The electric field produced by the applied voltage differential causes the positively charged holes 214 to migrate toward the cathode 202, and the negatively charged electrons 216 to migrate toward the anode 204, and consequently results in at least some of the holes 214 interacting with some of the electrons 216. When the holes 214 interact with the electrons 216, a recombination 220 generally occurs with the electron typically dropping to a lower energy level, and the recombination producing an emission of radiated energy 218, which depending upon properties of the materials used to form the emissive layer 210 and the conductive layer 212 is observable in the visual light spectrum. Because in organic semiconductors holes 214 are often more mobile than electrons 216, the recombination 220 typically occurs more proximate the cathode 202. The radiated energy 218, produced by the recombination generally initially propagates in a largely random direction with the radiated distribution being more uniform in all directions.

In many instances, the anode 204 is formed from indium tin oxide, a material which is largely transparent to visible light having a relatively high work function which is conducive to injecting holes into the intermediary conductive layer 212. In many instances, the cathode 202 is formed from a metal, such as aluminum, which has a relatively low work function well suited to injecting electrons into the intermediary emissive layer 210. While metals are traditionally considered to be non-transmissive, in some cases traditionally non-transmissive materials can become transmissive as the overall thickness of the material is made thinner. By making the material, in this case metal, used to form the cathode sufficiently thin, a degree of transmissivity can be achieved, in at least some cases. While making the metal used to form the cathode thinner will generally result in the metal cathode being more transmissive, a certain thickness needs to be maintained in order to insure the coverage and the integrity of the cathode in order to enable it to function as a conductive plate surface suitable for the function of a cathode for applying a charge and injecting electrons. By using a suitably thin layer of metal for the cathode, such as aluminum, and indium tin oxide for the anode, a transparent light emitting display is possible.

Given that the indium tin oxide used to form the anode generally has a greater level of transparency, than the cathode formed from the thin layer of metal, more of the light produced within the display will typically exit via the anode side of the display. Traditionally, designers have arranged the display within the device so as to expose the anode side of the display with the greater level of transparency toward the primary user, which coincides with the typical orientation of the display used relative to the device, when only a single side of the display was transparent. However, the present inventors have recognized certain beneficial effects are possible by reversing the orientation within a device, which is intended to be transparent in the area associated with the display, thereby emitting a greater amount of the light produced by the display in the direction away from the side of the device that is intended to face toward the primary user under typical use conditions.

While at least one set of circumstances which may be responsible for the generally disproportionate emission of light has been described above, one skilled in the art will recognize that a transparent display producing a disproportionate amount of light toward each of a primary side of the display and a secondary side of the display, to be emitted by the same, is possible under other circumstances. Regardless as to the cause of the disproportionate emission of light, by arranging the display such that the side of the display that is emitting the greater amount of light is oriented toward the side of the device facing away from the principal user under primary use conditions, the presently described beneficial effects can be achieved, in accordance with the teachings of the present application.

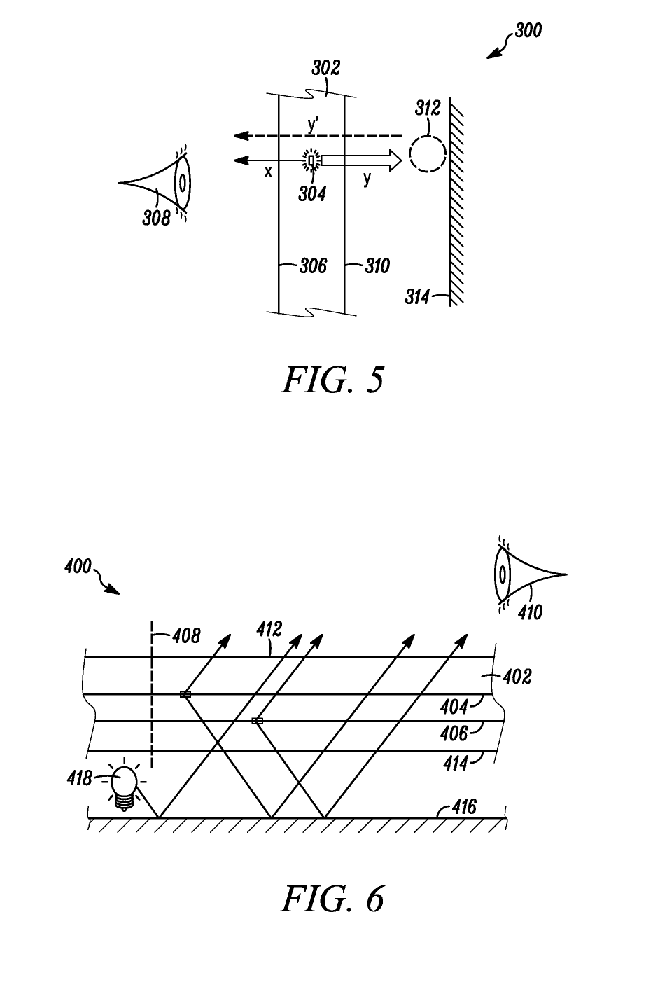

FIG. 5 illustrates a partial cross sectional side view 300 of a light emitting display 302, highlighting the actuation of a display element 304, and an exemplary emission of light from the actuated display element 304, in accordance with at least one aspect of the present invention. In accordance with at least one embodiment, the display element 304 emits a disproportionate amount of light in each of the direction x toward a front side surface 306, which is generally intended to be facing toward a principal user 308, and the direction y toward a back side surface 310, which is generally intended to be facing away from the principal user. As noted previously, the greater amount of emitted light is directed toward the back side surface 310 of the display and device in the direction y away from the principal user, at least initially. In some instances, some of the light emitted in a direction y away from the principal user 308 will interact with objects 312 or surfaces 314 located behind the device, and will reflect back y′ toward the user 308 through the device and the transparent display. In this way, objects 312 located behind the device/display 302, including the user's fingers which may be interacting with a touch sensitive surface on the rear side 310 of the device, may be visible to the user 308. Because a greater amount of the light y is at least initially emitted in a direction toward the back side surface 310 there is more light that can be potentially reflected back, such that when the light is reflected off of the rear positioned object 312 or surface 314, the amount of light which is reflected back y′ has a greater chance of being simultaneously viewable in conjunction with the light x emitted from the display element 304 in the direction toward the front side 306 of the device/display 302.

Alternatively, a secondary user (not shown) viewing the display 302 from the back side 310 of the device, may not be able to perceive enough of a reflected light originally emitted in a direction x of the front side surface 306 of the device/display 302 to be able to see objects located on the front side of the device/display 302, through the transparent display 302. Any reflected light from an object on the front side 306 of the device/display 302 may be overwhelmed by the intensity of light being directly produced by the display 302 and emitted toward the back side 310 of the device/display 302, thereby making any visual information carried by any such reflected light too faint to be perceived, when compared against the more directly emitted light.

FIG. 6 illustrates a further partial cross sectional side view 400 of a light emitting display 402, which includes a primary light emitting display 404 and a secondary light emitting display 406. In essence, the further embodiment highlights the possibility of a plurality of stacked light emitting displays, which together could be used to enable multiple planes of viewing. In at least some embodiments, the image plane of each of the primary light emitting display 404 and the secondary light emitting display 406 at least partially overlap in a direction 408 perpendicular to the image planes. In this way display images being produced and emitted by each of the light emitting displays 404 and 406 may be simultaneously viewable by a user 410 located in front of the device or on the front side 412 of the display. Similarly, objects and/or surfaces 416 located behind the device or on the back side 414 of the display 402 may also be simultaneously viewable, where the light reflected off of the objects and/or surfaces 416 may originate from one or both of the primary light emitting display 404 and the secondary light emitting display 406. The light may also originate from other sources 418.

In the illustrated embodiment, the light emitting display can include a touch sensor located on one or more of the front side surface of the device/display 412 and the back side surface of the device/display 414.

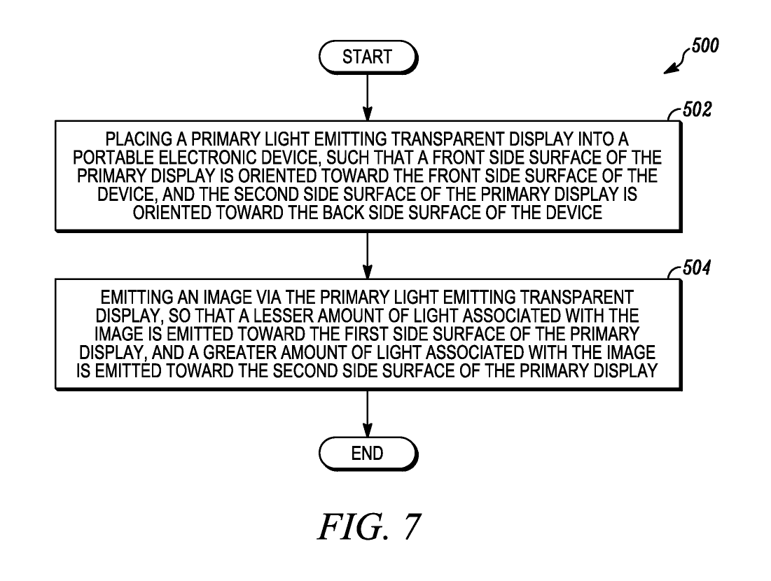

FIG. 7 illustrates a flow diagram 500 of a method for using one or more light emitting transparent displays in a portable electronic device. The method includes placing 502 a primary light emitting transparent display into a portable electronic device, such that a first side surface of the primary light emitting transparent display is oriented toward a front side surface of the portable electronic device, which is intended to be primarily used facing toward a principal user. Correspondingly, a second side surface of the primary light emitting transparent display is oriented toward a back side of the portable electronic device, which is intended to be primarily used facing away from the principal user. An image is then emitted 504 via the primary light emitting transparent display, so that a lesser amount of light associated with the image is emitted toward the first side surface of the primary light emitting transparent display, and a greater amount of light associated with the image is emitted toward the second side surface of the primary light emitting transparent display.

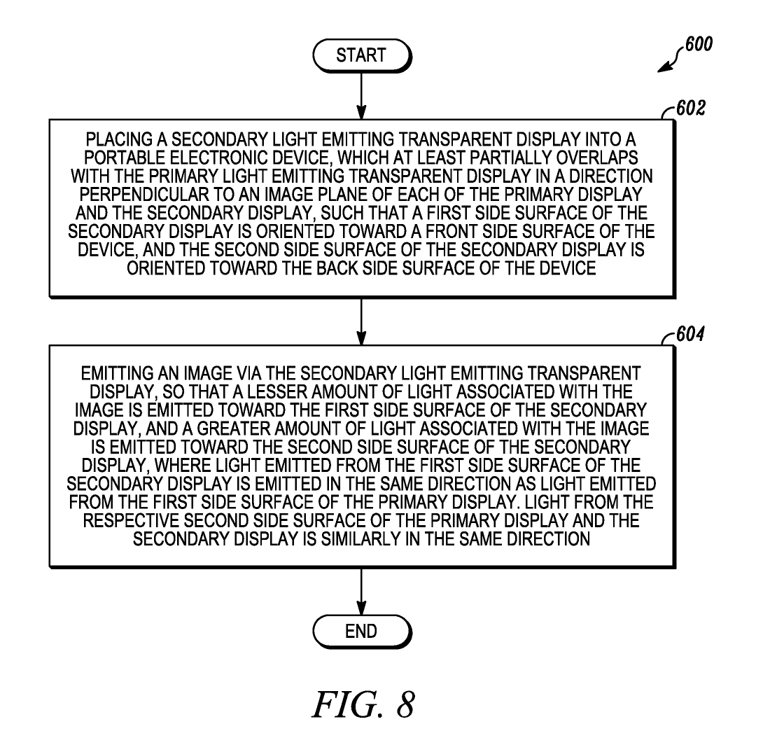

FIG. 8 illustrates a further flow diagram 600 of a method of using one or more light emitting transparent displays in a portable electronic device, in accordance with the method illustrated in FIG. 7, and including incorporating a secondary light emitting transparent display in addition to a primary light emitting transparent display, in a portable electronic device. The method further includes placing 602 a secondary light emitting transparent display into a portable electronic device, which at least partially overlaps with the primary light emitting transparent display in a direction perpendicular to an image plane of each of the primary light emitting transparent display and the secondary light emitting display. The secondary light emitting transparent display is placed such that a first side surface of the secondary light emitting transparent display is oriented toward a front side surface of the portable electronic device, which is intended to be primarily used facing toward a principal user, and such that a second side surface of the secondary light emitting transparent display is oriented toward a back side of the portable electronic device, which is intended to be primarily used facing away from the principal user. An image is then emitted 604 via the secondary transparent light emitting display, so that a lesser amount of light associated with the image is emitted toward the first side surface of the secondary light emitting transparent display, and a greater amount of light associated with the image is emitted toward the second side surface of the secondary light emitting transparent display, where the first side surface of the secondary light emitting transparent display emits light in the same direction of the first side surface of the primary light emitting transparent display, and the second side surface of the secondary light emitting transparent display emits light in the same direction of the second side surface of the primary light emitting transparent display.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A portable electronic device having a front side surface, which is intended to be primarily used facing toward a principal user and a back side surface, which is intended to be primarily used facing away from the principal user, the portable electronic device comprising:
a transparent display module including a primary light emitting transparent display having a first side surface and a second side surface, which emits a light toward each of the first side surface and the second side surface in disproportionate amounts, where an amount of light emitted toward the first side surface is less than an amount of light emitted toward the second side surface, and
wherein the transparent display module is mounted in the portable electronic device, so that the first side surface of the transparent display module which emits the lesser amount of light is oriented toward the front side surface of the portable electronic device, and the second side surface of the transparent display module which emits the greater amount of light is oriented toward the back side surface of the portable electronic device.

2. A portable electronic device in accordance with claim 1, wherein elements located behind the device can be seen in conjunction with and through an image produced by the primary light emitting transparent display.

3. A portable electronic device in accordance with claim 1, wherein the transparent display module further includes a touch sensor located on at least one of the first side surface of the primary light emitting transparent display or the second side surface of the primary light emitting transparent display.

4. A portable electronic device in accordance with claim 3, wherein the touch sensor includes a capacitive touch sensor adapted for detecting a location of a pointer element coming within proximity of the corresponding touch sensor.

5. A portable electronic device in accordance with claim 3, wherein the touch sensor includes a resistive touch sensor adapted for detecting a location and an amount of force of a pointer element coming into contact with the corresponding touch sensor

6. A portable electronic device in accordance with claim 1, wherein the display module further includes a secondary light emitting transparent display, which at least partially overlaps with the primary light emitting transparent display in a direction perpendicular to an image plane of each of the primary light emitting transparent display and the secondary light emitting display, the secondary light emitting transparent display having a first side surface and a second side surface, which emits a light toward each of the first side surface and the second side surface in disproportionate amounts, where an amount of light emitted by the secondary light emitting transparent display toward the first side surface is less than an amount of light emitted toward the second side surface, where the first side surface of the secondary light emitting transparent display is oriented in the same direction of the first side surface of the primary light emitting transparent display.

7. A portable electronic device in accordance with claim 6, wherein the image plane of the primary light emitting transparent display is substantially parallel to the image plane of the secondary light emitting transparent display.

8. A portable electronic device in accordance with claim 6, wherein an image produced by the primary light emitting transparent display and an image produced by the secondary light emitting transparent display are simultaneously perceivable by the user viewing the device from the front side surface.

9. A portable electronic device in accordance with claim 6, wherein the transparent display module further includes a first touch sensor located on the first side surface of the primary light emitting transparent display, and a second touch sensor located on the second side surface of the secondary light emitting transparent display.

10. A portable electronic device in accordance with claim 1, wherein the primary light emitting transparent display includes an emissive layer between an array of addressable anodes and an array of addressable cathodes.

11. A portable electronic device in accordance with claim 10, wherein the array of addressable cathodes are located on the first side surface of the emissive layer, and the array of addressable anodes are located on the second side surface of the emissive layer.

12. A portable electronic device in accordance with claim 11, wherein the cathode is formed from a metal having a thickness that is sufficiently thin to provide at least partial transmissivity, while maintaining sufficient conductive coverage.

13. A portable electronic device in accordance with claim 1, wherein the primary light emitting transparent display includes a transparent organic light emitting diode display.

14. A method for using one or more light emitting transparent displays in a portable electronic device comprising:
placing a primary light emitting transparent display into a portable electronic device, such that a first side surface of the primary light emitting transparent display is oriented toward a front side surface of the portable electronic device, which is intended to be primarily used facing toward a principal user, and such that a second side surface of the primary light emitting transparent display is oriented toward a back side of the portable electronic device, which is intended to be primarily used facing away from the principal user; and
emitting an image via the primary light emitting transparent display, so that a lesser amount of light associated with the image is emitted toward the first side surface of the primary light emitting transparent display, and a greater amount of light associated with the image is emitted toward the second side surface of the primary light emitting transparent display.

15. A method in accordance with claim 14, further comprising:
placing a secondary light emitting transparent display into a portable electronic device, which at least partially overlaps with the primary light emitting transparent display in a direction perpendicular to an image plane of each of the primary light emitting transparent display and the secondary light emitting display, such that a first side surface of the secondary light emitting transparent display is oriented toward a front side surface of the portable electronic device, which is intended to be primarily used facing toward a principal user, and such that a second side surface of the secondary light emitting transparent display is oriented toward a back side of the portable electronic device, which is intended to be primarily used facing away from the principal user; and
emitting an image via the secondary transparent light emitting display, so that a lesser amount of light associated with the image is emitted toward the first side surface of the secondary light emitting transparent display, and a greater amount of light associated with the image is emitted toward the second side surface of the secondary light emitting transparent display, where the first side surface of the secondary light emitting transparent display emits light in the same direction of the first side surface of the primary light emitting transparent display, and the second side surface of the secondary light emitting transparent display emits light in the same direction of the second side surface of the primary light emitting transparent display.
